(19) United States
(12) Patent Application Publication
(10) Pub. No.: US 2023/0335969 A1
(43) Pub. Date: Oct. 19, 2023

(54) Intracavity harmonic generation with layered nonlinear optic

(71) Applicant: Pavilion Integration Corporation, San Jose, CA (US)

(72) Inventors: Haiwen Wang, San Jose, CA (US); Jihchuang Robin Huang, San Jose, CA (US); Ningyi Luo, San Jose, CA (US)

(73) Assignee: Pavilion Integration Corporation, San Jose, CA (US)

(21) Appl. No.: 17/905,831

(22) PCT Filed: Aug. 24, 2022
(86) PCT No.: PCT/IB2022/057944

§ 371 Date: Feb. 19, 2023

Related U.S. Application Data
(60) Provisional application No. 63/236,674, filed on Aug. 24, 2021.
(60) Provisional application No. 63/339,447, filed on May 7, 2022.

(51) Int. Cl. H01S 3/109; G02F 1/37; G02F 1/355

(52) U.S. Cl. CPC H01S 3/109; G02F 1/37; G02F 1/3551; G02F 1/355

(57) ABSTRACT

This invention proposes to use a specially designed layered nonlinear optic (LNO) for intracavity harmonic generation. The LNO generates the harmonic and guides the generated harmonic beam to a different path from the fundamental beam path with total internal reflection, a phenomenon that all lights are reflected when lights in one (“internal”) optic strike sufficiently obliquely against the interface with a second (“external”) optic, in which the refractive index is lower than that in the internal optic. No coating is necessary for the harmonic inside the fundamental beam laser cavity. The generated harmonic beam does not travel through any surface inside the fundamental beam cavity, either. Hence this invention improves the reliability of intracavity harmonic generation laser especially if the harmonic is in the UV range.

### BACKGROUND

There are laser applications in many fields from biomedical, semiconductor, to defense industries. Different wavelengths are required for different applications. Some required wavelengths are hard to obtain by direct laser emission. One of the methods to extend laser wavelength range is through harmonic generation. There are two ways to generate harmonics, i.e., intracavity and extracavity harmonic generations. This invention mainly relates to intracavity harmonic generation.

FIG. 1 shows one known scheme for intracavity second harmonic generation (SHG). Item 107 is the pump beam that pumps the gain media 102. Item 101 is an optic that transmits the pump beam 107 while reflecting the fundamental beam 108. The laser cavity is between item 101 and item 105, which is an optic that reflects both the fundamental beam 108 and the second harmonic 106. The fundamental beam 108 oscillates inside the cavity along the beam path defined by items 101, 103, and 105. Item 103 is an optic that reflects the fundamental beam 108 but transmits the second harmonic beam 106 generated by the SHG nonlinear optic 104, both surfaces of which are anti-reflection (AR) coated for both the fundamental beam 108 and the second harmonic 106. Coatings of items 103, 104, and 105 are exposed to the second harmonic beam 106 and may be prone to degradation especially if the generated second harmonic is in the UV range. A slight coating degradation may cause significant decrease of output power because they are optics inside the fundamental beam cavity.

FIG. 2 shows one known scheme for intracavity third harmonic generation (THG). Item 217 is the pump beam that pumps the gain media 209. Item 208 is an optic that transmits the pump beam 217 while reflecting the fundamental beam 218. The laser cavity is between item 208 and item 214, which is an optic that reflects both the fundamental beam 218 and second harmonic 216. Item 210 is an optic that reflects the fundamental beam 218 and transmits the residual second harmonic beam 216. The fundamental beam 218 oscillates inside the cavity along the beam path defined by items 208, 210, and 214. Item 213 is a SHG nonlinear optic that generates the second harmonic beam 216. Both the fundamental beam 218 and second harmonic 216 enter THG optic 212 and generate third harmonic 215. The third harmonic 215 is reflected out of the cavity by item 211, which also transmits the fundamental beam 218 and residual second harmonic 216. Coatings of items 211 and 212 are exposed to the third harmonic beam 215 and may be prone to degradation especially if the generated third harmonic is in the UV range. A slight coating degradation may cause significant decrease of output power because they are optics inside the fundamental beam cavity.

### SUMMARY OF THE INVENTION

This invention proposes to use a specially designed layered nonlinear optic (LNO) for intracavity harmonic generation. The LNO generates the harmonic and guides the generated harmonic beam to a different path from the fundamental beam path with total internal reflection, a phenomenon that all lights are reflected when lights in one (“internal”) optic strike sufficiently obliquely against the interface with a second (“external”) optic, in which the refractive index is lower than that in the internal optic. No coating is necessary for the harmonic inside the fundamental beam laser cavity. The generated harmonic beam does not travel through any surface inside the fundamental beam cavity, either. Hence this invention improves the reliability of intracavity harmonic generation laser especially if the harmonic is in the UV range.

The proposed LNO for intracavity harmonic generation is a layered structure comprising one layer of nonlinear optic, which generates the harmonics, and at least one other optical layer to guide the generated harmonic out of the fundamental beam cavity with total internal reflection. These optics are bonded together without any adhesives, for example using optical contacting. No coating for the generated harmonic is necessary inside the fundamental beam cavity. The generated harmonic does not travel through any surfaces inside the fundamental beam cavity, either. All the layers may be chosen to be refractive index matched for the fundamental beam to minimize the loss for the fundamental beam.

### DESCRIPTION OF THE DRAWING

The invention will be described with respect to a drawing in several figures.

FIG. 1 shows a known scheme for intracavity second harmonic generation (SHG).

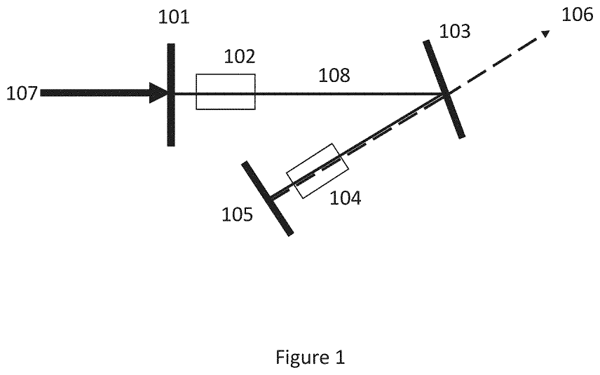

FIG. 2 shows a known scheme for intracavity third harmonic generation (THG).

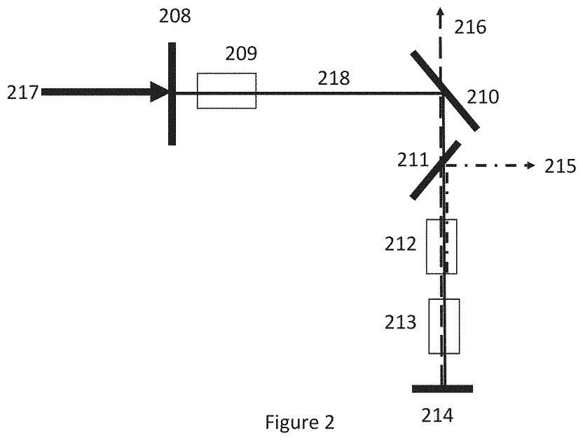

FIG. 3 shows a layered nonlinear optic or LNO for intracavity SHG.

FIG. 4 shows an example of the LNO application in intracavity SHG.

FIG. 5 shows a reflective optic added in a first way to back-reflect the second harmonic.

FIG. 6 shows a reflective optic added in a second way to back-reflect the second harmonic.

FIG. 7 shows a detailed example of the LNO for ooe SHG.

FIG. 8 shows an example of the LNO application in an intracavity THG.

FIG. 9a shows the third harmonic exiting at a side face.

FIG. 9b shows the third harmonic exiting at a bottom face.

FIG. 10 shows a two-layered LNO taking the place of the three-layered LNO of FIG. 8.

FIG. 11 shows an example of the LNO for ooe THG.

FIG. 12 shows LNO being used for intracavity fourth harmonic generation (FHG).

FIG. 13 shows an example of intracavity SHG in a unidirectional laser using a two-layered LNO.

### DETAILED DESCRIPTION

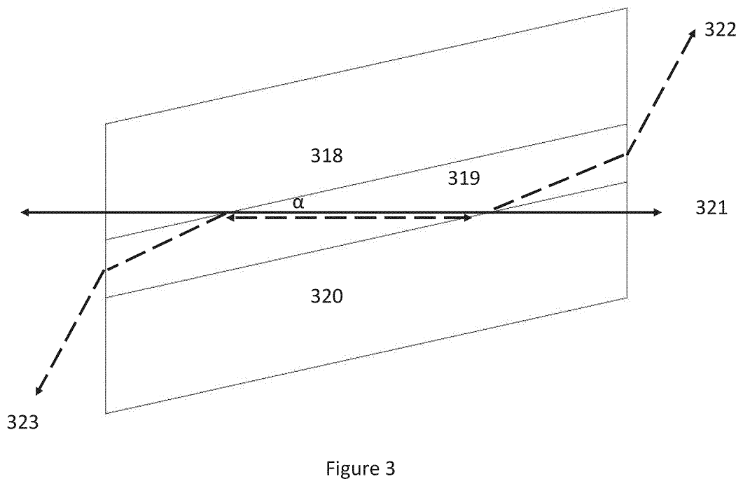

FIG. 3 illustrates an LNO for intracavity SHG. Item 319 is a nonlinear optic for SHG, sandwiched between items 318 and 320, which are chosen so that their refractive indices for the second harmonic are lower than that of item 319. The angle α is chosen so that the second harmonics 322 and 323 generated inside item 319 experience total internal reflection at the interfaces between items 318 and 319 and between items 319 and 320 while no total internal reflection is experienced by the fundamental beam 321 at either interface. One way to understand the structure is to think of items 318 and 319 as cladding materials that create a light guide to confine the second harmonic beam 322 and 323 inside item 319 until it reaches the exit surfaces at its sides. The exit surfaces can be chosen to be Brewster surfaces, so as to avoid a need for AR coating. The refractive indices of items 318, 319, and 320 considered from the point of view of the fundamental beam 321 can be chosen to be the same, or nearly same, as each other, to minimize the loss for the fundamental beam 321.

The material employed for the nonlinear optic may be β-BBO (beta-barium borate), LBO (lithuim triborate), CLBO (cesium lithium borate), KBBF (KBe₂BO₃F₂), BiBO (bismuth borate), KTP (potassium titanyl phosphate), KD*P (potassium dideuterium phosphate), PPLN (periodically poled lithium niobate), PPSLT (periodically poled stoichiometric lithium tantalate), or PP-LBGO (periodically poled LaBGeO₅).

The material employed for cladding layers 318 and 320 (the lower-refractive-index materials) may be α-BBO (alpha-barium borate), β-BBO (beta-barium borate), LBO (lithium triborate), CLBO (cesium lithium borate), KBBF (KBe₂BO₃F₂), BiBO (bismuth borate), KTP (potassium titanyl phosphate), KD*P (potassium dideuterium phosphate, YVO₄, LiNbO₃, LiTaO₃, LBGO, crystal quartz, fused silica, BK₇, and CaF₂.

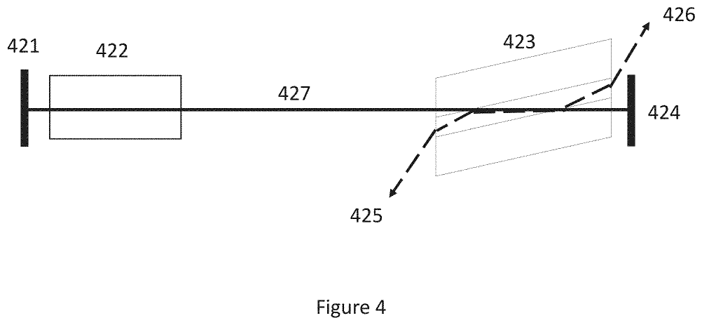

An example of the LNO application in intracavity SHG is illustrated in FIG. 4. Items 421 and 424 are two end optics that form the fundamental beam laser cavity. Item 422 is the gain medium. The pumping source is omitted for clarity in this figure, because this invention applies to all pumping methods, such as optical, electrical, or other pumping methods. The fundamental beam 427 oscillates inside the cavity defined by items 421 and 424. Item 423 is the LNO described in FIG. 3. Items 425 and 426 are two second-harmonic beams generated by the LNO.

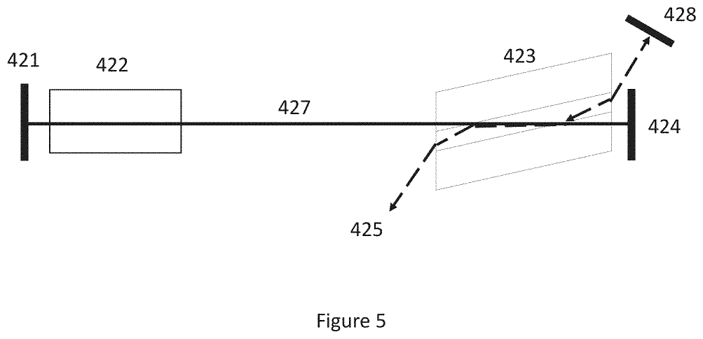

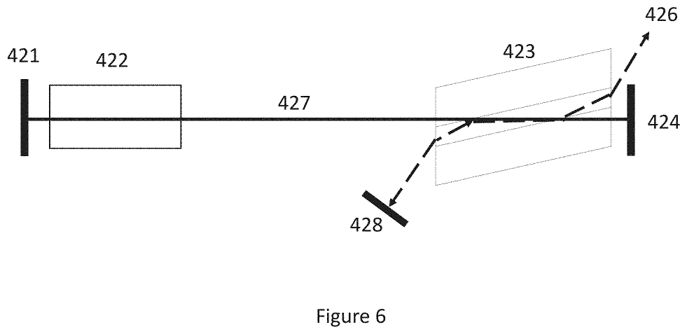

If it is desired to have only one output beam rather than two output beams, an optic 428 can be added to back-reflect the second harmonic as shown in FIG. 5 or FIG. 6 so that there is only one output second harmonic beam. Optic 428 can be designed in a way so that the spatial mode of the back-reflected second harmonic beam matches that of the other second harmonic beam.

For the discussion that follows it will be helpful to define some terms. The defined terms will permit efficient discussion of particular aspects of the invention as it relates to nonlinear optics. By “birefringent optic” we mean an optic whose refractive index varies depending on the polarization and propagation direction of light impinging upon or passing through the optic. We define a term “ordinary light (o)” as a light the polarization of which is perpendicular to the optical axis of a birefringent optic. We define a term “extraordinary light (e)” as a light the polarization of which and propagation direction form a plane that is parallel to the optical axis of a birefringent optic, and its polarization is not perpendicular to the optical axis. This permits us to define yet another term, namely “ooe SHG” which means that the fundamental light for the SHG is ordinary light and the generated second harmonic is extraordinary light.

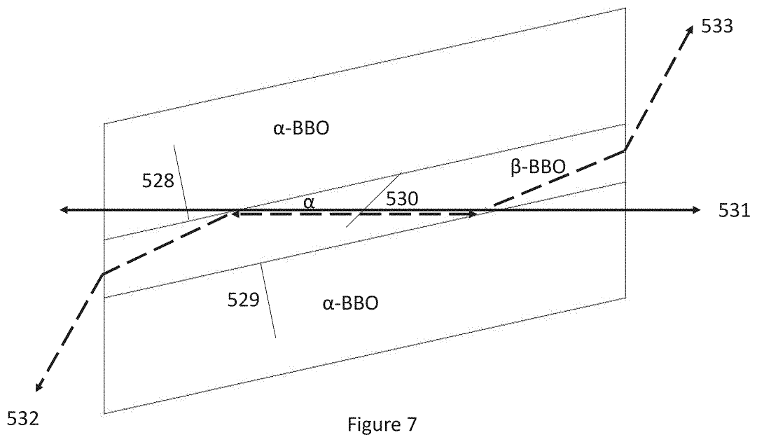

A detailed example of the LNO is shown in FIG. 7 for ooe SHG. The nonlinear β-BBO is sandwiched between two layers of α-BBO. Items 528, 529, and 530 are optical axes of the top α-BBO, bottom α-BBO, and β-BBO, respectively. The optical axes of the two α-BBO layers (items 528 and 529) are all perpendicular to interfaces with β-BBO. The optical axis of the β-BBO (item 530) is parallel to the paper plane (the plane in which the figure lies), and the orientation inside the paper plane is determined by SHG phase matching. The polarization of fundamental beam 531 is perpendicular to the paper plane. It is ordinary light in all three layers. The fundamental beam goes through the whole LNO essentially in a straight line with no loss because the refractive indices are essentially the same in α-BBO and β-BBO. The refractive index of the second harmonics 532 and 533, which is extraordinary beam, are higher inside β-BBO. Hence total internal reflection can be realized if the incident angles are larger than the critical angle. For example, choose a to be 15.2° for ooe SHG of 698 nm. It not only realizes the total internal reflection, but also permits the second harmonics 532 and 533 to exit the LNO at a Brewster angle if the sides of LNO are cut perpendicular to the fundamental beam 531. The alert reader will appreciate that although the example given here is the use of ooe SHG, the benefits of such an LNO structure apply to other types of SHG as well, including quasi phase-matched SHG.

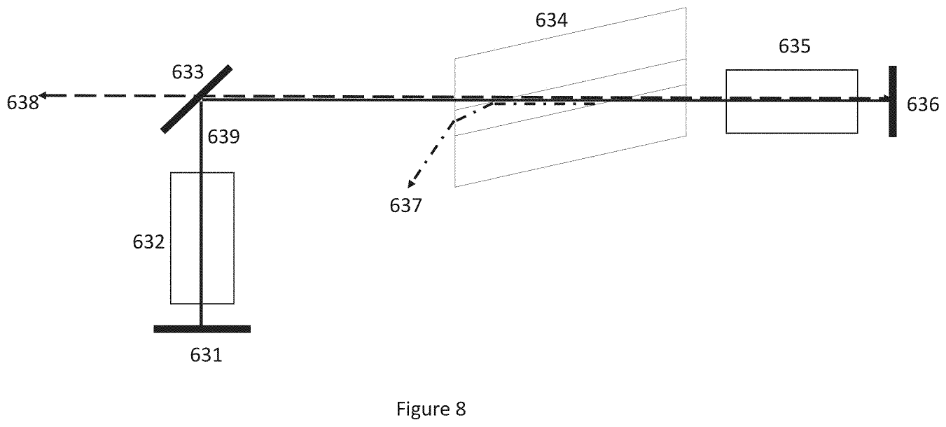

An example of the LNO application in intracavity THG is illustrated in FIG. 8. Items 631 and 636 are two end optics that form the fundamental beam laser cavity. Item 632 is the gain medium. The pumping source is omitted for clarity because this invention applies to all pumping methods, such as optical, electrical, or other pumping methods. Item 633 is an optic that reflects the fundamental beam 639 and transmits the residual second harmonic beam 638. The fundamental beam 639 oscillates inside the cavity along the beam path defined by items 631, 633, and 636. Item 634 is an LNO. The fundamental beam 639 and the second harmonic 638 generated by second harmonic nonlinear optic 635 go through the LNO while the third harmonic 637 is reflected out of the cavity. No coating for the third harmonic is necessary inside the laser cavity. It will be appreciated that the third harmonic 637 does not travel through any surfaces inside the laser cavity. The exit surface can be chosen to be a Brewster surface so that no AR coating is necessary. The refractive indices of the materials, from the point of view of the fundamental beam 639, can be selected in all layers to be the same or nearly same as each other, to minimize the loss for the fundamental beam 639. The second harmonic 638 does not have to be collinear with the fundamental beam 639 after the third harmonic is generated. The second harmonic 638 does not have to travel through the LNO. It can be totally reflected by the LNO like as the third harmonic 637, or can be partially reflected.

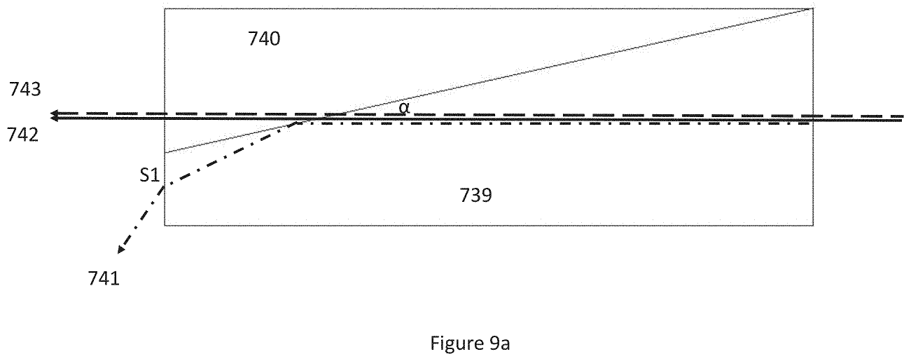

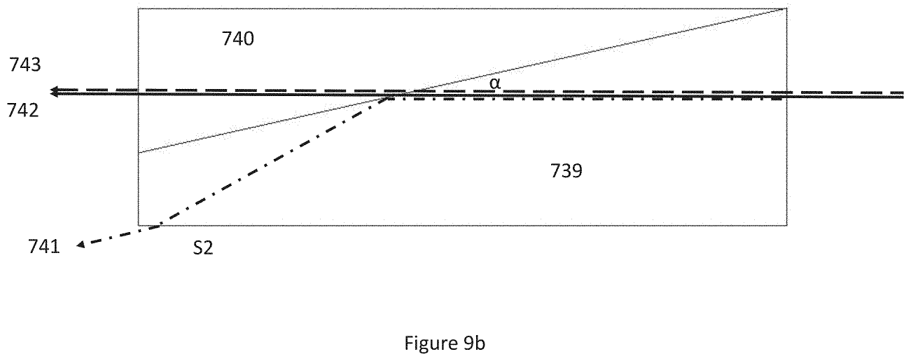

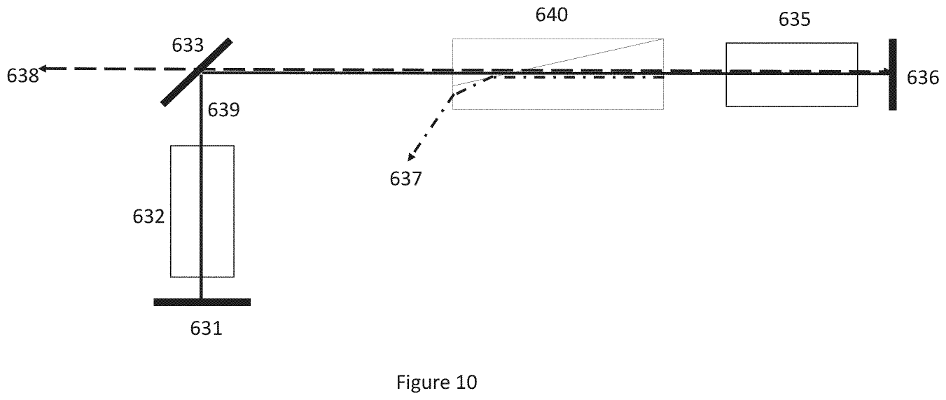

A simpler two layered LNO can also be used for THG as shown in FIGS. 9a and 9b. Item 739 is a nonlinear THG optic layer. The refractive index of optical layer 740 is lower than that of item 739 for the generated third harmonic 741. The angle α is chosen so that the third harmonic 741 generated inside item 739 experiences total internal reflection at the interface between items 739 and 740 while no total internal reflection is experienced by the fundamental beam 742 at the interface. The third harmonic 741 exits item 739 at a side face S1 as shown in FIG. 9a, which may be designed to be a Brewster surface to avoid AR coating. Alternatively, the third harmonic 741 can exit item 739 at the bottom face S2 as shown in FIG. 9b, which may also be designed to be a Brewster surface to avoid AR coating. The refractive indices of the materials, from the perspective of the fundamental beam 742, can be selected in both layers to be the same or nearly the same, so as to minimize the loss for the fundamental beam. The second harmonic 743 does not have to be collinear with the fundamental beam 742 after the third harmonic 741 is generated. The second harmonic 743 does not have to travel through the upper layer 740. It can be totally reflected at the interface between layers 739 and 740, or can be partially reflected there. This two-layered LNO can replace item 634 in FIG. 8. The whole setup is shown in FIG. 10, where item 640 is the two-layered LNO.

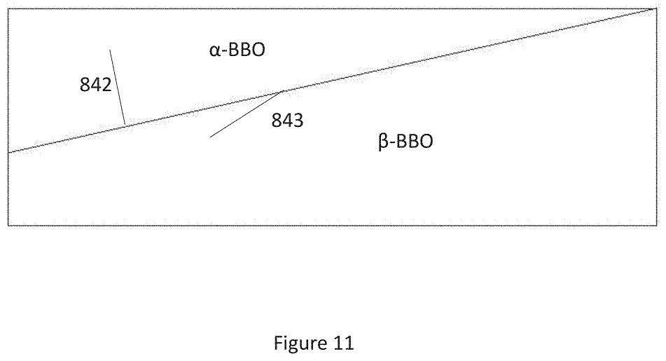

An example of the LNO is shown in FIG. 11 for ooe THG. Items 842 and 843 are optical axes of α-BBO and β-BBO, respectively. The optical axis of the α-BBO (item 842) is perpendicular to the interface with β-BBO. The optical axis of the β-BBO (item 843) is parallel to the paper plane and the orientation inside the paper plane is determined by THG phase matching.

Here we show an example of intracavity THG using the LNO shown in FIG. 11. The same scheme will be employed as shown in FIG. 10. The polarization of the fundamental beam 639 is perpendicular to the paper plane. SHG optic 635 is selected to be a PPLN (Periodically Poled Lithium Niobate). The polarization of the second harmonic 638 generated by item 635 is also perpendicular to the paper plane. Both the fundamental beam 639 and the second harmonic 638 are ordinary light in both layers of item 640. The fundamental beam 639 and second harmonic 638 go through the whole LNO essentially in a straight line with no loss because the refractive indices are essentially the same for α-BBO and β-BBO, for those beams. The refractive index of the third harmonic 637, which is an extraordinary beam, is higher in the β-BBO layer. Hence total internal reflection of the third harmonic 637 can be realized if the incident angle is larger than the critical angle. Once again the alert reader appreciates that although the example given is that of ooe THG, the benefits of the LNO structure offer themselves to other types of THG as well, including quasi phase-matched THG.

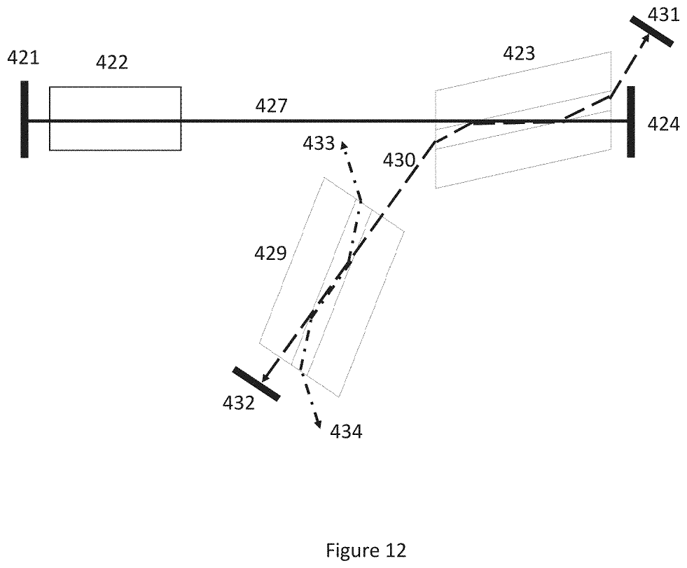

LNO can be also used for intracavity fourth-harmonic generation (FHG). The scheme can be based on the intracavity SHG approach shown in FIG. 4. FIG. 12 illustrates such a scheme. Items 431 and 432 are the two end optics that create a cavity for the second harmonic 430 generated by the fundamental beam 427. One of end optics 431 and 432 is controlled by a feedback loop to lock the phase of the second harmonic beam 430. Another LNO 429 is designed for SHG of the second harmonic 430. Items 433 and 434 are two-output fourth harmonic beams. Again, the exit surfaces of LNO 429 can be designed to be Brewster surfaces for the fourth harmonics, so that no AR coating is necessary.

The same principle can be applied for intracavity 2ⁿth harmonic generations where n>2.

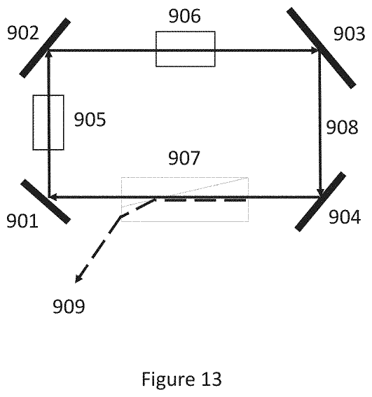

LNO can be used in unidirectional lasers, too. An example of intracavity SHG in a unidirectional laser using a two layered LNO is shown in FIG. 13. Optics 901, 902, 903, and 904 form a cavity for the fundamental beam 908. Item 905 is the gain medium. The pumping source is omitted for clarity because this invention applies to all pumping methods, such as optical, electrical, or other pumping methods. Item 906 is a unidirectional optical gate that forces unidirectional operation. Item 907 is a two-layered LNO that generates the second harmonic 909.

If the harmonic generation is critically phase-matched, there is walkoff between the ordinary and the extraordinary beams. The acceptance angles are also different in two directions, i.e., the direction that is perpendicular to optical axis and its orthogonal direction. The generated harmonic beam becomes elliptical. Many laser manufacturers use beam-shaping optics to convert the harmonic to a round output beam.

In some applications, however, elliptical focusing is preferred. Usually beam-shaping optics are utilized to focus round or close-to-round beams to elliptical focusing. Here we propose a method to obtain elliptical focusing directly without beam shaping optics. When the elliptical harmonic beam mentioned in the paragraph above is focused without beam shaping, the beam waist sizes and locations are different in two directions, i.e., the direction that is perpendicular to optical axis and its orthogonal direction. Elliptical foci with different major and minor axis ratios can be obtained at different locations around the two beam waist positions. Increasing the harmonic crystal length will increase the walkoff and make the harmonic beam more elliptical. Hence the maximum major and minor axis ratio reachable around the focus is larger with a longer harmonic crystal. In our SHG experiment with a 3 mm and a 5 mm long BBO, elliptical focusing of the second harmonic with major and minor axis ratios of 3:1 and 4:1 have been obtained respectively with a single focusing lens and no beam shaping optics.

The alert reader will have no difficulty devising myriad obvious improvements and variants of the invention, all of which are intended to be encompassed by the claims which follow.

1. An intracavity harmonic-generation laser comprising at least one layered nonlinear optic (LNO) comprising:
a first optical layer of nonlinear optic that generates a harmonic;
second and third optical layers, each having a respective face, disposed on opposite faces of the first optical layer, defining respective interfaces;
each of the first, second, and third optical layers characterized by a respective refractive index;
the refractive indices of the first and second optical layers selected so that with respect to the generated harmonic, the interface between the first and second optical layers gives rise to total internal reflection thereof;
the refractive indices of the first and third optical layers selected so that with respect to the generated harmonic, the interface between the first and third optical layers gives rise to total internal reflection thereof;
whereby the generated harmonic exits the first optical layer as at least one beam through a surface other than the interface with the second optical layer and other than the interface with the third optical layer;
the faces of the first and second optical layers bonded together in a manner free from adhesive; and
the faces of the first and third optical layers bonded together in a manner free from adhesive.

2. The laser of claim 1, wherein the bonding is optical contacting, frit bonding, or diffusion bonding.

3. The laser of claim 1, wherein the wherein the optical layer faces are dielectric coated before the bonding.

4. The laser of claim 1, wherein the intracavity harmonic generation is intracavity second harmonic generation.

5. The laser of claim 1, wherein the intracavity harmonic generation is intracavity third harmonic generation.

6. The laser of claim 1, wherein the intracavity harmonic generation is intracavity fourth harmonic generation, or intracavity 2ⁿth harmonic generation, where n>2.

7. The laser of claim 1, wherein the laser is a bidirectional laser or a unidirectional laser.

8. The laser of claim 1, wherein the laser is a bidirectional laser.

9. The laser of claim 1, wherein the LNO comprises one optical layer of nonlinear harmonic optic, which generates the desired harmonic, sandwiched between the second and third optical layers.

10. The laser of claim 9, wherein the respective refractive indices of the second and third optical layers each lower than that of the first optical layer, with respect to the harmonic generated by the LNO.

11. The laser of claim 9, wherein there is a fundamental beam passing through the first optical layer, the second optical layer, and the third optical layer, and wherein the first optical layer and the second and third optical layers are refractive-index matched with respect to the fundamental beam.

12. The laser of claim 9, wherein the first optical layer comprises β-BBO, LBO, CLBO, KBBF, BiBO, KTP, KD*P, PPLN, PPSLT, or PP-LBGO.

13. The laser of claim 9, wherein each of the second optical layer and third optical comprises α-BBO, β-BBO, CLBO, KBBF, BiBO, KTP, KD*P, YVO4, LiNbO3, LiTaO3, LBGO, crystal quartz, fused silica, BK7, or CaF2.

14. The laser of claim 9, wherein the harmonic beam generated by LNO exits the first optical layer at Brewster angle.

15. An intracavity harmonic-generation laser with at least one layered nonlinear optic (LNO) comprising:
a first optical layer of nonlinear optic that generates a harmonic;
a second optical layer having a respective face, disposed on a face of the first optical layer, defining an interface;
each of the first and second optical layers characterized by a respective refractive index;
the refractive indices of the first and second optical layers selected so that with respect to the generated harmonic, the interface between the first and second optical layers gives rise to total internal reflection thereof;
whereby the generated harmonic exits the first optical layer as at least one beam through a surface other than the interface with the second optical layer;
the faces of the first and second optical layers bonded together in a manner free from adhesive.

16. The laser of claim 15, wherein the bonding is optical contacting, frit bonding, or diffusion bonding.

17. The laser of claim 15, wherein the wherein the optical layer faces are dielectric coated before the bonding.

18. The laser of claim 15, wherein the intracavity harmonic generation is intracavity second harmonic generation.

19. The laser of claim 15, wherein the intracavity harmonic generation is intracavity third harmonic generation.

20. The laser of claim 15, wherein the laser is a bidirectional laser or a unidirectional laser.

21. The laser of claim 15, wherein the laser is a bidirectional laser.

22. The laser of claim 15, wherein the LNO comprises one optical layer of nonlinear harmonic optic, which generates the desired harmonic, and a second layer.

23. The laser of claim 22, wherein the refractive index of the second optical layer is lower than that of the first optical layer, with respect to the harmonic generated by the LNO.

24. The laser of claim 22, wherein there is a fundamental beam passing through the first optical layer and the second optical layer, wherein the first optical layer and the second optical layer are refractive-index matched with respect to the fundamental beam.

25. The laser of claim 22, wherein the first optical layer comprises β-BBO, LBO, CLBO, KBBF, BiBO, KTP, KD*P, PPLN, PPSLT, or PP-LBGO.

26. The laser of claim 22, wherein the second optical layer comprises α-BBO, β-BBO, CLBO, KBBF, BiBO, KTP, KD*P, YVO4, LiNbO3, LiTaO3, LBGO, crystal quartz, fused silica, BK7, or CaF2.

27. The laser of claim 22, wherein the harmonic beam generated by LNO exits the first optical layer at Brewster angle.

28-32. (canceled)

33. A method of generating a harmonic beam carried out with respect to a layered nonlinear optic (LNO) comprising a first optical layer of nonlinear optic that generates a harmonic, a second optical layer having a respective face, disposed on a face of the first optical layer, defining an interface, each of the first and second optical layers characterized by a respective refractive index, the refractive indices of the first and second optical layers selected so that with respect to the generated harmonic, the interface between the first and second optical layers gives rise to total internal reflection thereof, whereby the generated harmonic exits the first optical layer as at least one beam through a surface other than the interface with the second optical layer, the faces of the first and second optical layers bonded together in a manner free from adhesive, the method comprising the steps of:
a. passing a fundamental beam through the first optical layer and the second optical layer;
b. generating a harmonic within the first optical layer;
c. permitting a generated harmonic beam to exit the first optical layer through a surface other than the interface with the second optical layer.

34. A method of generating a harmonic beam carried out with respect to a layered nonlinear optic (LNO) comprising a first optical layer of nonlinear optic that generates a harmonic, second and third optical layers, each having a respective face, disposed on opposite faces of the first optical layer, defining respective interfaces, each of the first, second, and third optical layers characterized by a respective refractive index, the refractive indices of the first and second optical layers selected so that with respect to the generated harmonic, the interface between the first and second optical layers gives rise to total internal reflection thereof, the refractive indices of the first and third optical layers selected so that with respect to the generated harmonic, the interface between the first and third optical layers gives rise to total internal reflection thereof, whereby the generated harmonic exits the first optical layer as at least one beam through a surface other than the interface with the second optical layer and other than the interface with the third optical layer, the faces of the first and second optical layers bonded together in a manner free from adhesive, and the faces of the first and third optical layers bonded together in a manner free from adhesive, the method comprising the steps of:
passing a fundamental beam through the first optical layer and the second optical layer and the third optical layer;
generating a harmonic within the first optical layer;
permitting a generated harmonic beam to exit the first optical layer through a surface other than the interface with the second optical layer and other than the interface with the third optical layer.
